(19) United States
(12) Patent Application Publication
(10) Pub. No.: US 2025/0279673 A1
(43) Pub. Date: Sep. 4, 2025

(54) ELECTRIC UTILITY PROXY METER

(71) Applicant: Aclara Technologies LLC, St. Louis, MO (US)

(72) Inventor: David Donald Haynes, St. Peters, MO (US)

(21) Appl. No.: 19/068,842

(22) Filed: May 13, 2025

Related U.S. Application Data
(63) Continuation of application No. 16/423,701, filed on May 28, 2019, now abandoned.
(60) Provisional application No. 62/677,429, filed on May 29, 2018.

(51) Int. Cl. H02J 13/00; G01D 4/00; G06Q 50/06; H04L 9/40

(52) U.S. Cl. CPC H02J 13/00017; G01D 4/002; H02J 13/00006; H04L 63/0442; G06Q 50/06

(57) ABSTRACT

An electrical distribution system (D) in which the consumption of electricity supplied to a facility (F) is measured by an electric meter (HM) installed a relatively inaccessible or hard to reach facility location. A proxy meter (PM) is installed at a readily accessible or easy to reach facility location. The proxy meter is linked to the host meter (HM) for energy consumption measurements made by the host meter to be sent to the proxy meter for ready transmission to the utility (U). Instructions or directives for the host meter are transmitted to the proxy meter by the utility and sent by the proxy meter to the host meter for the host meter to act on or respond to them.

### REFERENCE TO RELATED APPLICATIONS

This application is based on, and claims the benefit of, U.S. Non-Provisional patent application Ser. No. 16/423,701, filed May 28, 2019, which claims priority to U.S. Provisional Patent Application 62/677,429 filed May 29, 2018, each of which is which is incorporated herein by reference.

### BACKGROUND OF THE INVENTION

This disclosure relates to electric meters installed at facilities (homes, businesses, etc.) serviced by an electrical utility to measure the amount of electricity consumed at a facility; and, more particularly, to a meter, referred to hereafter as a “proxy” meter, located at a readily accessible location at the facility and in communication with a meter actually measuring the amount of electricity consumed at the facility but located at a remote, relatively inaccessible location.

Utilities supplying electricity to consumers employ a meter installed at the consumer's facility to measure the amount of electricity consumed at the facility and provide appropriate consumption data back to the utility for billing and other purposes. Many new meters, often referred to as “smart” meters, now also receive and execute instructions from the utility to control electrical usage at the facility or perform other functions and communicate on a regular basis with the utility. In many installations, communications between the utility and meter are radio frequency or RF communications using an advanced metering infrastructure (AMI) capability incorporated in the meter.

Meters installed at people's homes are typically installed on the outside of the building and RF communication between the utility and consumer site are easy and straightforward. And, such meters are readily accessible for someone (a utility worker) to manually read them. However, in commercial buildings, factories, and the like, an electricity meter is often located in a relatively inaccessible area such a basement, a room that may be kept locked, or a vault or the like. In these locations, RF communications may be difficult, if not impossible, and access by utility personnel may be on a restricted basis not conducive to the needs of the utility in servicing its customers.

It would be helpful therefor, in these instances, to have the capability of readily accessing the information in a meter and/or communicating with the meter for controlling electrical usage at the facility where an inaccessible meter is installed.

### BRIEF SUMMARY OF THE INVENTION

The present invention is directed to a proxy meter for use by an electric utility that, in effect, relocates a “hard to reach” meter installed at a facility to a facility location that is easy to reach or access.

In such an installation, the proxy meter is linked to a primary or host meter installed at the location and which measures the consumption of electricity. The proxy meter is located at the easy to reach location and measurements made by the host meter are transmitted to the proxy meter via a link between them. Data sent from the host meter to the proxy meter is read the same way at the proxy meter as if it were being read at the host meter. Also, the transmitted data is stored in the proxy meter so a copy thereof is readily available to the utility. In effect, host meter data is “mirrored” by the proxy meter.

In addition to mirroring energy consumption data read by the host meter, commands for the host meter are accepted by the proxy meter and sent to the host meter via the link for execution by the host meter.

Other objects and features will be in-part apparent and in-part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a simplified representation of an installation of a proxy meter with a host meter; and,

FIG. 2 illustrates an installation of the host and proxy meters at a facility serviced by an electrical utility.

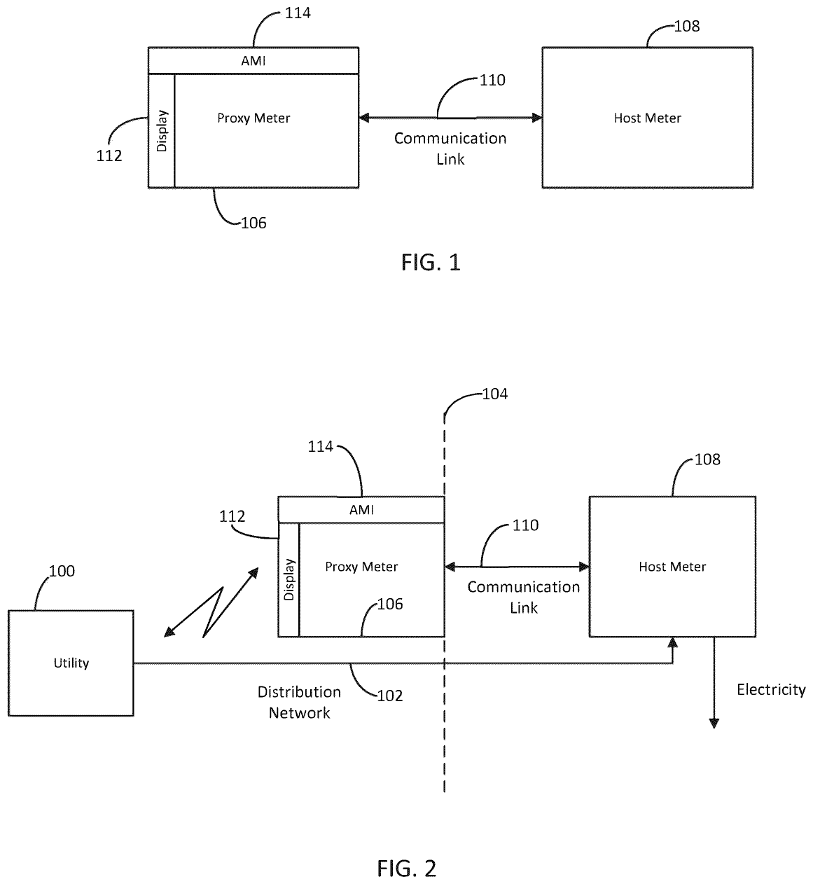

Corresponding reference characters indicate corresponding parts throughout the views of the drawings.

### DETAILED DESCRIPTION OF INVENTION

The following detailed description illustrates the invention by way of example and not by way of limitation. This description clearly enables one skilled in the art to make and use the invention including what is currently believed to be the best mode for carrying out the invention. It will be understood that is not limited in its application to the details of construction and arrangement of components set forth in the following description or illustrated in the accompanying drawings. The invention is capable of other embodiments and of being practiced or carried out in various ways. Also, the phraseology and terminology used herein is for the purposes of description and should not be regarded as limiting.

Referring to the drawings, as is well known in the art, a utility U supplies electricity E through a power distribution network D to numerous using facilities F. At a facility F, the electricity is routed through an electrical meter installed thereat which measures the amount of electricity consumed and provides usage data back to the utility for billing and other purposes. If the meter is a “smart” meter it will also receive and execute instructions from the utility to control electrical usage at the facility or perform other functions. As previously noted, communications between the utility and meter are RF communications using an AMI capability incorporated in the meter.

As shown in FIG. 2, the present invention is directed to a proxy meter PM installed at the facility in a readily accessible location and electrically connected to a primary or host meter HM. As discussed above, host meter HM is installed within the facility at a relatively inaccessible location. Electricity to the facility is routed through host meter HM for measurement of the amount of electricity consumed. Now, host meter HM sends this data to proxy meter PM over a bi-directional communications link L so that the proxy meter effectively mirrors the operation of the host meter. The protocol used for data transfer can be a standard or a proprietary protocol. Further, if communications between the meters are to be secure communications, encryption and authentication protocols are also employed.

Proxy meter PM, which is powered by an AC or DC voltage supplied by host meter HM, displays the data measured by the host meter on a visual display V located on a front panel of the proxy meter. Proxy meter PM can also transmit this data, using an AMI module installed in the proxy meter, to the utility over a communications path not readily available, or difficult to use, between the utility and host meter HM. If the data is to be read by a utility worker or the like, the worker can conveniently read the information off display V.

For smart meter applications, the AMI network used by the utility now communicates with proxy meter PM which transmits the received instructions or other directives to proxy meter PM over link L. Link L comprises a hardwired cable connected between ports on the respective meters. Wires used in the cable comprising link L are rated at, for example, 600V or higher (depending on the service voltage provided by the utility). Data lines in the cable are optically isolated.

Preferably, link L comprises a RS-485 data link. However, in other embodiments of the invention, link L may comprise a RS-232 data link, or a fiber optic data link. Also, Wi-Fi, Zigbee®, or other communication protocols can be used for communications between the meters.

Host meter HM and proxy meter PM are preferably the same model of meter and have the same physical size and appearance. However, as shown in FIG. 2, those skilled in the art will understand that proxy meter PM is not a meter as such, since it takes no measurements. In addition, while host meter HM may include a remote connect/disconnect switch or an input/output (I/O) board, these accessories are not necessary for proxy meter PM.

As noted, proxy meter PM may be powered by AC supplied by host meter HM. In such instances, wires forming any hardwired link L between the meters need to be optically isolated, or RF may be used.

In view of the foregoing the many advantages of the invention and other useful benefits are achieved.

1. In an electrical distribution system for a utility in which the consumption of electricity supplied to a facility is measured by an electric meter installed within the facility at a relatively inaccessible or hard to reach location, a proxy meter installed at a readily accessible or easy to reach location at the facility, the proxy meter being in communication with the first said or host meter for measurements of energy consumption made by the host meter to be transmitted to the proxy meter for ready transmission to the utility, and for instructions or directives for the host meter to be transmitted from the utility to the proxy meter for transmittal by the proxy meter to the host meter for the host meter to act on or respond to them.

2. The proxy meter of claim 1 which mirrors operations of the host meter with regard to energy consumption data transmission to the utility and storage.

3. The proxy meter of claim 1 having a visual display by which someone can read energy consumption data off the display.

4. The proxy meter of claim 1 further including an AMI module installed therewithin for communications with the utility.

5. The proxy meter of claim 1 which is powered by the host meter.

6. The proxy meter of claim 1 in which a communications link between the host meter and proxy meter comprises a hardwired cable connected between ports on the respective meters.

7. The proxy meter of claim 6 in which wires installed in the cable comprising the link are rated at approximately 600V or higher depending on the service voltage provided by the utility.

8. The proxy meter of claim 6 in which data lines in the cable are optically isolated from each other.

9. The proxy meter of claim 6 in which the link comprises one of: a RS-485 data link;
a RS-232 data link; or, a fiber optic data link.

10. The proxy meter of claim 1 in which communications between the host meter and the proxy meter use either a standard or a proprietary protocol; and if communications between the host and proxy meters are to be secure communications, encryption and authentication protocols are also employed.
